(19) United States
(12) Patent Application Publication
(10) Pub. No.: US 2013/0069930 A1
(43) Pub. Date: Mar. 21, 2013

(54) SHIFT REGISTER, SCANNING SIGNAL LINE DRIVE CIRCUIT, AND DISPLAY DEVICE

(71) Applicants: Tetsuo Fukaya, Osaka-shi (JP); Masashi Yonemaru, Osaka-shi (JP); Kenichi Ishii, Osaka-shi (JP); Masahiko Nakamizo, Osaka-shi (JP)

(72) Inventors: Tetsuo Fukaya, Osaka-shi (JP); Masashi Yonemaru, Osaka-shi (JP); Kenichi Ishii, Osaka-shi (JP); Masahiko Nakamizo, Osaka-shi (JP)

(73) Assignee: SHARP KABUSHIKI KAISHA, Osaka (JP)

(21) Appl. No.: 13/635,414

(22) PCT Filed: Oct. 29, 2010
(86) PCT No.: PCT/JP2010/069321

§ 371 Date: Sep. 15, 2012

(30) Foreign Application Priority Data
Mar. 15, 2010 (JP) 2010-057180

(51) Int. Cl. G09G 3/36

(52) U.S. Cl. CPC G09G 3/3648
USPC 345/214

(57) ABSTRACT

A bistable circuit includes an output terminal that outputs a state signal, an output terminal that outputs an other-stage control signal, a first node of which a potential is controlled based on a set signal and a clear signal, a thin-film transistor that provides a potential of a second clock to the output terminal when a potential of the first node is at a high level, a thin-film transistor that provides a potential of a first clock to the output terminal when a potential of the first node is at a high level, and a thin-film transistor for changing a potential of the other-stage control signal to a low level based on a reset signal. The first clock is generated by a power source of a different system from the second clock, and has a smaller amplitude than that of the second clock.

### TECHNICAL FIELD

The present invention relates to a display device and a drive circuit therefor and, more particularly, to a shift register in a scanning signal line drive circuit that drives scanning signal lines arranged in a display unit of a display device.

### BACKGROUND ART

In recent years, in a liquid crystal display device, monolithic fabrication of a gate driver (a scanning signal line drive circuit) for driving a gate bus line (a scanning signal line) is being progressed. Conventionally, a gate driver is mounted in many cases as an IC (Integrated Circuit) chip on a peripheral portion of a substrate that constitutes a liquid crystal panel. However, in recent years, the practice in which the gate driver is directly formed on the substrate is gradually performed in many cases. Such a gate driver is called a “monolithic gate driver”, for example. In a liquid crystal display device that includes the monolithic gate driver, a thin-film transistor that uses amorphous silicon (a-Si) (hereinafter, referred to as “a-SiTFT”) is typically employed as a drive element.

Incidentally, in a display unit of an active matrix-type liquid crystal display device, there is formed a pixel circuit that includes a plurality of source bus lines (video signal lines), a plurality of gate bus lines, and a plurality of pixel formation portions that are provided at respective intersections of the plurality of source bus lines and the plurality of gate bus lines. The plurality of pixel formation portions constitute a pixel array by being arrayed in a matrix form. Each of the pixel formation portions includes a thin-film transistor which is a switching element having a gate terminal connected to a gate bus line passing through a corresponding intersection and having a source terminal connected to a source bus line passing through the intersection; and a pixel capacitance for holding a pixel voltage value. In the active matrix-type liquid crystal display device, there are further provided the gate driver, and a source driver (a video signal line drive circuit) for driving the source bus line.

Although video signals that indicate pixel voltage values are transmitted by the source bus lines, each of the source bus lines cannot transmit at one time (simultaneously) the video signals that indicate the pixel voltage values of a plurality of rows. Therefore, writing (charging) of the video signal to the pixel capacitance in the pixel formation portions arrayed in the matrix form is performed sequentially for each one row. Consequently, the gate driver is configured by a shift register that includes a plurality of stages such that a plurality of gate bus lines are sequentially selected for each predetermined period. Each stage of the shift register is a bistable circuit that is in either one of two states (a first state and a second state) at each time point and that outputs a signal indicating this state (hereinafter, referred to as a “state signal”) as a scanning signal. The writing of the video signal to the pixel capacitance is sequentially performed for each one row, as described above, based on sequential output of active scanning signals from the plurality of bistable circuits in the shift register.

FIG. 19 is a circuit diagram showing a typical configuration in the vicinity of an output portion of the bistable circuit in the shift register. As shown in FIG. 19, a thin-film transistor T90 that has a source terminal (a second conductive terminal) connected to an output terminal 92 for outputting a state signal Q is provided in the vicinity of the output portion of the bistable circuit. An on/off state of the thin-film transistor T90 in each bistable circuit is controlled by a clock signal that is transmitted from an outside of the shift register and a state signal that is outputted from a bistable circuit of a preceding stage or a subsequent stage of the corresponding each bistable circuit. A clock signal CK is provided via an input terminal 91, to a drain terminal (a first conductive terminal) of the thin-film transistor T90. In such a configuration, the thin-film transistor T90 in each bistable circuit becomes in an on state only once during one vertical scanning period. When the thin-film transistor T90 is in an on state, a potential of the clock signal CK that is being provided to the input terminal 91 is provided to the output terminal 92. In the following, a transistor for controlling output of the state signal Q like the thin-film transistor T90 is also referred to as an “output control transistor”.

Note that Japanese Patent Application Laid-Open No. 2006-107692 discloses an example of a configuration of one stage component (a configuration of a bistable circuit) of a shift register that is provided in a gate driver of a display device.

### PRIOR ART DOCUMENT

### Patent Document

[Patent Document 1] Japanese Patent Application Laid-Open No. 2006-107692

### SUMMARY OF THE INVENTION

### Problems to be Solved by the Invention

According to the conventional configuration shown in FIG. 19, the clock signal that is transmitted from the outside of the shift register controls an on/off state of the output control transistor of each bistable circuit and is also being provided to a drain terminal of the output control transistor. According to the shift register that employs an a-SiTFT as a drive element, conventionally, a potential at a high-level side of the clock signal described above is defined based on a pixel rated voltage which is a voltage required for driving a pixel circuit and is also the voltage which is defined for each panel. The pixel rated voltage becomes large with the progress of size increase and higher resolution in panels. Therefore, with the progress of size increase and higher resolution in panels, power consumption in the shift register increases. Regarding this point, suppose a potential at the high-level side of the clock signal is set lower than a conventional potential to reduce power consumption in the conventional configuration. Then a potential that is provided to a first conductive terminal of the output control transistor (a drain terminal of the thin-film transistor T90 in FIG. 19) also becomes lower than a conventional potential. Consequently, a potential provided to the output terminal 92 when the output control transistor is in an on state becomes lower than a conventional potential. Accordingly, when the potential at the high-level side of the clock signal is set lower to about a level at which an effect of power consumption reduction is sufficiently obtained, a sufficient voltage required to drive a liquid crystal cannot be obtained.

Therefore, an object of the present invention is to reduce power consumption in a monolithic gate driver as compared with that in the past, without lowering a voltage applied to the gate bus line.

### Means for Solving the Problems

A first aspect of the present invention is directed to a shift register, being provided on a substrate on which a pixel circuit for displaying an image is formed, and comprising a plurality of bistable circuits each having a first state and a second state and being connected in series to each other, the plurality of bistable circuits sequentially becoming in a first state based on a circuit-control clock signal provided from an outside of each bistable circuit, wherein

each bistable circuit includes:
a first output node outputting a state signal indicating one of the first state and the second state to an outside;
an output-control switching element having a control terminal, a first conductive terminal, and a second conductive terminal, the second conductive element being connected to the first output node;
a second output node outputting an other-stage control signal for controlling an operation of a bistable circuit other than said each bistable circuit; and
a control unit controlling a potential of a first node connected to the control terminal of the output-control switching element and a potential of the second output node, based on the circuit-control clock signal and the other-stage control signal outputted from a bistable circuit other than said each bistable circuit, and wherein

a potential supplied by a power source of a system separate from a system of a power source generating the circuit-control clock signal is provided to the first conductive terminal of the output-control switching element, and

a first potential as a potential at a high-level side of the circuit-control clock signal is lower than a second potential as a potential to be provided to the first conductive terminal of the output-control switching element during a period in which the state signal is to be set to the first state.

According to a second aspect of the present invention, in the first aspect of the present invention,

a clock signal whose potential at a high-level side is set to the second potential is provided to the first conductive terminal of the output-control switching element.

According to a third aspect of the present invention, in the first aspect of the present invention,

each bistable circuit further includes a switching element for lowering a potential of the first output node based on the circuit-control clock signal or an other-stage control signal outputted from a bistable circuit other than said each bistable circuit, and

a potential that is being provided to the first conductive terminal of the output-control switching element is supplied by a direct-current power source.

According to a fourth aspect of the present invention, in the first aspect of the present invention,

a potential based on a pixel rated voltage which is a voltage defined to drive the pixel circuit is provided to the first conductive terminal of the output-control switching element.

According to a fifth aspect of the present invention, in the fourth aspect of the present invention,

a size of the first potential is equal to or larger than a half of a size of a potential based on the pixel rated voltage.

A sixth aspect of the present invention is directed to a scanning signal line drive circuit of a display device, for driving a plurality of scanning signal lines arrayed in a display unit including the pixel circuit, the scanning signal line drive circuit comprising:

the shift register according to a fifth aspect of the present invention, wherein

the plurality of bistable circuits are provided to correspond to the plurality of scanning signal lines at one to one, and

each bistable circuit provides a state signal outputted from the first output node, to a scanning signal line corresponding to said each bistable circuit, as a scanning signal.

A seventh aspect of the present invention is directed to a display device including the display unit, comprising:

a scanning signal line drive circuit according to a sixth aspect of the present invention.

### Effects of the Invention

According to the first aspect of the present invention, from each bistable circuit in the shift register, the state signal and the other-stage control signal which is for controlling a bistable circuit of a stage which is different from that of the corresponding each bistable circuit are outputted. The second potential being a relatively high potential is provided to the first conductive terminal of the output-control switching element having the second conductive terminal connected to the first output node that outputs the state signal. The potential of the second output node that outputs the other-stage control signal is controlled by the circuit-control clock signal of which the potential at the high-level side is the first potential as the potential lower than the second potential. In general, power consumption due to a circuit parasitic capacitance is proportional to a product of a square of a voltage (an amplitude), a capacitance value of the parasitic capacitance, and a frequency. Therefore, the power consumption is greatly reduced, by making an amplitude of the circuit-control clock signal, of which a frequency is relatively large, smaller than that in the past. Further, when the second potential is set sufficiently high, a drive capacity of the shift register is not made lower than a conventional drive capacity. From the above, by applying this shift register to a scanning signal line drive circuit of the display device, for example, the power consumption in the scanning signal line drive circuit is reduced as compared with that in the past, without lowering a voltage applied to a scanning signal line.

According to the second aspect of the present invention, in the shift register of a configuration in which a clock signal is provided to the first conductive terminal of the output-control switching element, power consumption is reduced without lowering the drive capacity of the shift register.

According to the third aspect of the present invention, a direct-current voltage is provided to the first conductive terminal of the output-control switching element. Therefore, power consumption attributable to a parasitic capacitance of the output-control switching element is not generated during an operation of the shift register. Thus, the power consumption in the shift register is substantially reduced as compared with that in the past.

According to the fourth aspect of the present invention, the pixel rated voltage is provided to the first conductive terminal of the output-control switching element. Therefore, the power consumption in the shift register can be reduced as compared with that in the past, while securely preventing reduction in voltage applied to the scanning signal line.

According to the fifth aspect of the present invention, the power consumption in the shift register is reduced as compared with that in the past, while preventing occurrence of an abnormal operation of a circuit.

According to the sixth aspect of the present invention, the scanning signal line drive circuit that includes the shift register capable of obtaining a similar effect to that of the first aspect of the present invention is realized.

According to the seventh aspect of the present invention, the display device that includes the scanning signal line drive circuit capable of obtaining a similar effect to that of the sixth aspect of the present invention is realized.

### BRIEF DESCRIPTION OF THE DRAWINGS

FIG. 1 is a circuit diagram showing a configuration of a bistable circuit that is included in a shift register in a gate driver in a liquid crystal display device according to a first embodiment of the present invention.

FIG. 2 is a block diagram showing an overall configuration of the liquid crystal display device in the first embodiment.

FIG. 3 is a block diagram for describing a configuration of the gate driver in the first embodiment.

FIG. 4 is a block diagram showing a configuration of the shift register in the gate driver in the first embodiment.

FIG. 5 is a signal waveform diagram for describing an operation of the gate driver in the first embodiment.

FIG. 6 is a signal waveform diagram for describing an operation of the bistable circuit in the first embodiment.

FIG. 7 is a diagram showing a relationship between a control signal voltage and power consumption in the first embodiment.

FIGS. 8A and 8B are diagrams for describing an effect in the first embodiment.

FIGS. 9A and 9B are diagrams for describing an effect in the first embodiment.

FIGS. 10A and 10B are diagrams for describing an effect in the first embodiment.

FIG. 11 is a diagram for describing a modification of the first embodiment.

FIG. 12 is a circuit diagram showing a configuration example of a bistable circuit in the modification of the first embodiment.

FIG. 13 is a signal waveform diagram for describing an operation of the bistable circuit according to the modification of the first embodiment.

FIG. 14 is a block diagram showing a configuration of a shift register in a gate driver in a liquid crystal display device according to a second embodiment of the present invention.

FIG. 15 is a circuit diagram showing a configuration of a bistable circuit that is included in the shift register in the gate driver in the second embodiment.

FIG. 16 is a signal waveform diagram for describing an operation of a bistable circuit in the second embodiment.

FIGS. 17A and 17B are diagrams for describing an effect in the second embodiment.

FIG. 18 is a diagram for describing a modification of the second embodiment.

FIG. 19 is a circuit diagram showing a typical configuration in the vicinity of an output portion of a bistable circuit in a shift register in a conventional example.

### MODES FOR CARRYING OUT THE INVENTION

Embodiments of the present invention will be described below with reference to the accompanying drawings. Note that in the following description, a gate terminal (a gate electrode) of a thin-film transistor corresponds to a control terminal, a drain terminal (a drain electrode) corresponds to a first conductive terminal, and a source terminal (a source electrode) corresponds to a second conductive terminal. Further, a description will be given on the premise that all the thin-film transistors provided in a bistable circuit are n-channel type transistors.

### 1. First Embodiment

### 1.1 Overall Configuration and Operation

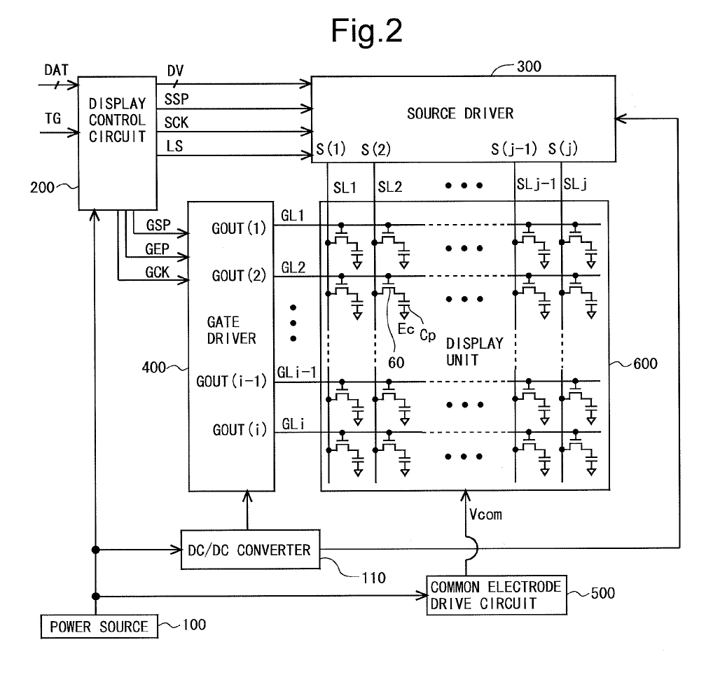

FIG. 2 is a block diagram showing an overall configuration of an active matrix-type liquid crystal display device according to a first embodiment of the present invention. As shown in FIG. 2, this liquid crystal display device includes a power source 100, a DC/DC converter 110, a display control circuit 200, a source driver (a video signal line drive circuit) 300, a gate driver (a scanning signal line drive circuit) 400, a common electrode drive circuit 500, and a display unit 600. Note that the gate driver 400 is formed on a display panel that includes the display unit 600, by using amorphous silicon. That is, in the present embodiment, both the gate driver 400 and the display unit 600 are formed on the same substrate (an array substrate as one of two substrates that constitute a liquid crystal panel).

In the display unit 600, there is formed a pixel circuit that includes a plurality of (j) source bus lines (video signal lines) SL1 to SLj, a plurality of (i) gate bus lines (scanning signal lines) GL1 to GLi, and a plurality of (i×j) pixel formation portions which are provided at respective intersections of the source bus lines SL1 to SLj and the gate bus line GL1 to GLi. The plurality of pixel formation portions constitute a pixel array by being arrayed in a matrix form. Each pixel formation portion includes a thin-film transistor (TFT) 60 which is a switching element having a gate terminal connected to a gate bus line passing through a corresponding intersection and having a source terminal connected to a source bus line passing through the intersection, a pixel electrode connected to a drain terminal of the thin-film transistor 60, a common electrode Ec which is a counter electrode provided so as to be shared by the plurality of pixel formation portions, and a liquid crystal layer that is provided so as to be shared by the plurality of pixel formation portions and that is sandwiched between the pixel electrode and the common electrode Ec. A pixel capacitance Cp is configured by a liquid crystal capacitance that is formed by the pixel electrode and the common electrode Ec. Note that an auxiliary capacitance is normally provided in parallel with the liquid crystal capacitance to securely hold a potential in the pixel capacitance Cp. However, since the auxiliary capacitance is not directly related to the present invention, description and drawings thereof are omitted.

The power source 100 supplies a predetermined power source voltage to the DC/DC converter 110, the display control circuit 200, and the common electrode drive circuit 500. The DC/DC converter 110 generates a predetermined direct-current voltage to operate the source driver 300 and the gate driver 400, from the power source voltage, and supplies the direct-current potential to the source driver 300 and the gate driver 400. The common electrode drive circuit 500 supplies a predetermined voltage Vcom to the common electrode Ec.

The display control circuit 200 receives an image signal DAT and a timing signal group TG such as a horizontal synchronous signal and a vertical synchronous signal that are transmitted from an outside, and outputs a digital video signal DV; and a source start pulse signal SSP, a source clock signal SCK, a latch strobe signal LS, a gate start pulse signal GSP, a gate end pulse signal GEP, and a gate clock signal GCK, for controlling an image display in the display unit 600. As will be described later, in the present embodiment, the gate clock signal GCK is configured by two-phase clock signals CK1 (hereinafter, referred to as a “first gate clock signal”) and CK2 (hereinafter, referred to as a “second gate clock signal”) that have relatively small amplitudes, and two-phase clock signals CK1H (hereinafter, referred to as a “third gate clock signal”) and CK2H (hereinafter, referred to as a “fourth gate clock signal”) that have relatively large amplitudes. Note that for all the signals of the first to fourth gate clock signals, potentials at low-level sides are set the same. Further, potentials at high-level sides of the third gate clock signal CK1H and the fourth gate clock signal CK2H are set to potentials corresponding to a voltage at a high-level side of a pixel rated voltage which is a voltage required for driving the pixel circuit and is also a voltage defined for each panel. Further, potentials at high-level sides of a first gate clock signal CK1 and a second gate clock signal CK2 are set lower than the potential at the high-level side of the pixel rated voltage, and are also typically set to potentials of a size equal to or larger than a half of the potential at the high-level side of the pixel rated voltage. Specifically, for example, for the first gate clock signal CK1 and the second gate clock signal CK2, potentials at the high-level sides are set to 20 V, and potentials at the low-level sides are set to −8 V, and for the third gate clock signal CK1H and the fourth gate clock signal CK2H, potentials at the high-level sides are set to 35 V, and potentials at the low-level sides are set to −8 V.

The source driver 300 receives the digital video signal DV, the source start pulse signal SSP, the source clock signal SCK, and the latch strobe signal LS that are outputted from the display control circuit 200, and applies driving video signals S(1) to S(j) to the source bus lines SL1 to SLj, respectively.

The gate driver 400 repeats application of active scanning signals GOUT(1) to GOUT(i) to the gate bus lines GL1 to GLi, by using one vertical scanning period as a cycle, based on the gate start pulse signal GSP, the gate end pulse signal GEP, and the gate clock signal GCK that are outputted from the display control circuit 200. Note that a detailed description of the gate driver 400 will be described later.

As described above, based on the application of the driving video signals S(1) to S(j) to the source bus lines SL1 to SLj, and based on the application of the scanning signals GOUT(1) to GOUT(i) to the gate bus lines GL1 to GLi, an image based on the image signal DAT that is transmitted from the outside is displayed in the display unit 600.

### 1.2 Configuration and Operation of Gate Driver

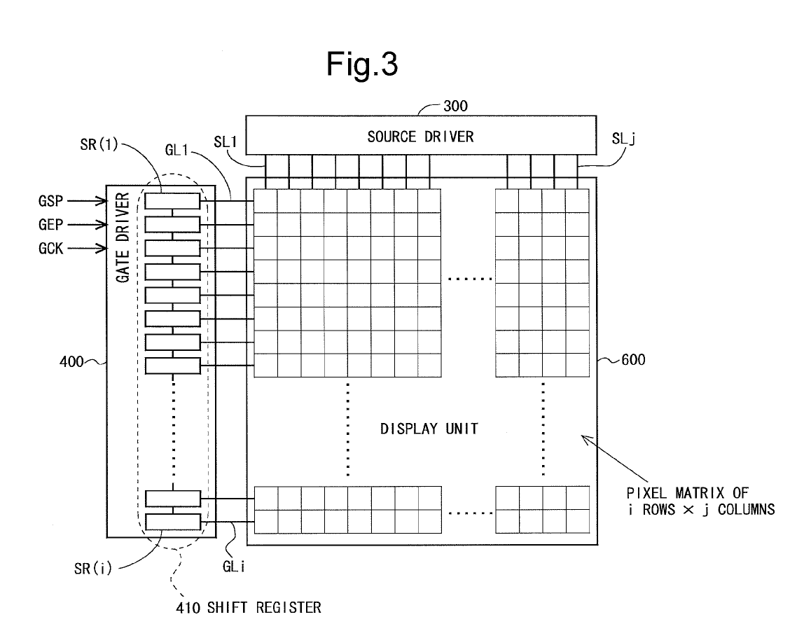

Next, a configuration and an outline of an operation of the gate driver 400 according to the present embodiment will be described with reference to FIGS. 3 to 5. As shown in FIG. 3, the gate driver 400 is configured by a shift register 410 including a plurality of stages. A pixel matrix of i rows x j columns is formed in the display unit 600, and each stage of the shift register 410 is provided to correspond to each row of the pixel matrix at one to one. Each stage of the shift register 410 is a bistable circuit that is in either one of two states (a first state and a second state) at each time point and that outputs a signal showing this state (hereinafter, referred to as a “state signal”). In this way, the shift register 410 is configured by i bistable circuits SR(1) to SR(i). Note that in the present embodiment, when a bistable circuit is in the first state, the bistable circuit outputs a state signal of a high level (an H level), and when a bistable circuit is in the second state, the bistable circuit outputs a state signal of a low level (an L level). In the following, a period during which a bistable circuit outputs a state signal of a high level and a scanning signal of a high level is applied to a gate bus line corresponding to the bistable circuit is referred to as a “selected period”.

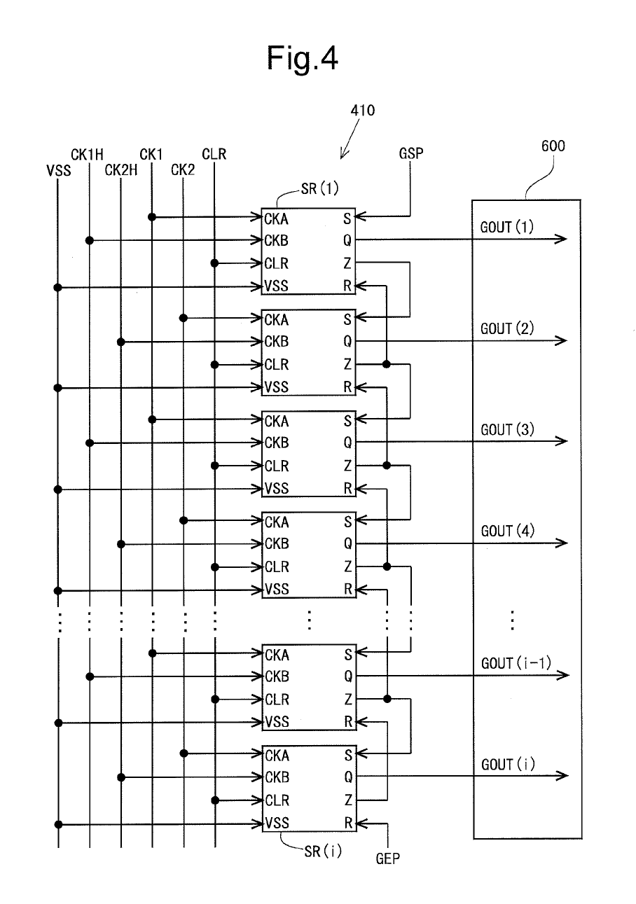

FIG. 4 is a block diagram showing a configuration of the shift register 410 in the gate driver 400. As described above, the shift register 410 is configured by the i bistable circuits SR(1) to SR(i). Each bistable circuit is provided with an input terminal for receiving a clock signal CKA (hereinafter, referred to as a “first clock”) of a relatively small amplitude, an input terminal for receiving a clock signal CKB (hereinafter, referred to as a “second clock”) of a relatively large amplitude, an input terminal for receiving a clear signal CLR to initialize all the bistable circuits, an input terminal for receiving a direct-current power source potential VSS of a low level, an input terminal for receiving a set signal S, an input terminal for receiving a reset signal R, an output terminal for outputting the state signal Q, and an output terminal for outputting a signal (hereinafter, referred to as a “other-stage control signal”) Z for controlling an operation of a bistable circuit of a stage which is different from that of the corresponding each bistable circuit.

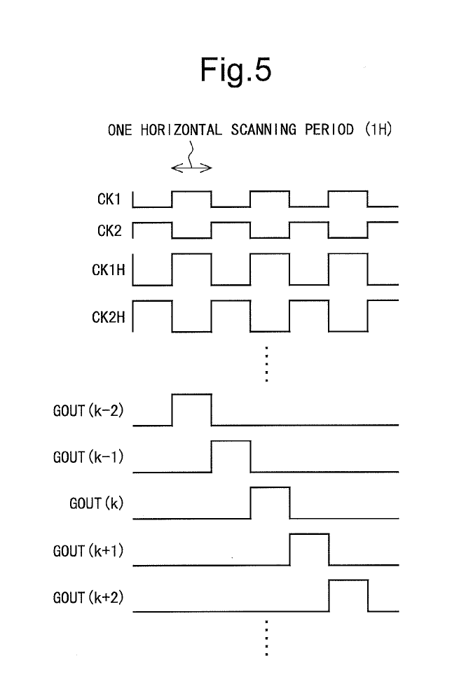

The shift register 410 is provided, as the gate clock signal GCK, with the first gate clock signal CK1 and the second gate clock signal CK2 as two-phase clock signals having relatively small amplitudes, and the third gate clock signal CK1H and the fourth gate clock signal CK2H as two-phase clock signals having relatively large amplitudes. For the first gate clock signal CK1 and the second gate clock signal CK2, phases are shifted by one horizontal scanning period from each other, and each of them becomes in a state of a high level (H level) during one horizontal scanning period out of two horizontal scanning periods, as shown in FIG. 5. Likewise for the third gate clock signal CK1H and the fourth gate clock signal CK2H, phases are shifted by one horizontal scanning period from each other, and each of them becomes in a state of a high level (H level) during one horizontal scanning period out of two horizontal scanning periods, as shown in FIG. 5. Further, the first gate clock signal CK1 and the third gate clock signal CK1H are in the same phase.

Signals that are provided to input terminals of each stage (each bistable circuit) of the shift register 410 are as follows (see FIG. 4). In odd stages, the first gate clock signal CK1 is provided as the first clock CKA, and the third gate clock signal CK1H is provided as the second clock CKB. In even stages, the second gate clock signal CK2 is provided as the first clock CKA, and the fourth gate clock signal CK2H is provided as the second clock CKB. In a first stage, the gate start pulse signal GSP is provided as the set signal S. In a second stage and subsequent stages, the other-stage control signal Z that is outputted from a preceding stage is provided as the set signal S. Further, in an i-th stage, the gate end pulse signal GEP is provided as the reset signal R. In an (i-1)-th stage and preceding stages, the other-stage control signal Z that is outputted from a subsequent stage is provided as the reset signal R. The clear signal CLR and the direct-current power source potential VSS of a low level are commonly provided to all the bistable circuits.

The state signal Q and the other-stage control signal Z are outputted from each stage (each bistable circuit) of the shift register 410. The state signal Q that is outputted from each stage is provided as a scanning signal to a corresponding gate bus line. The other-stage control signal Z that is outputted from each stage is provided to a preceding stage as the reset signal R, and is also provided to a subsequent stage as the set signal S.

In the above configuration, when the gate start pulse signal GSP as the set signal S is provided to a first stage SR(1) of the shift register 410, a pulse (this pulse is included in the other-stage control signal Z outputted from each stage) that is included in the gate start pulse signal GSP is sequentially transferred from the first-stage SR(1) to an i-th stage SR(i), based on the gate clock signal GCK (the first gate clock signal CK1, the second gate clock signal CK2, the third gate clock signal CK1H, and the fourth gate clock signal CK2H). The state signals Q that are outputted from the stages SR(1) to SR(i) sequentially become at a high level, in response to this pulse transfer. The state signals Q that are outputted from the stages SR(1) to SR(i) are provided to the gate bus lines GL1 to GLi as the scanning signals GOUT(1) to GOUT(i). As a result, as shown in FIG. 5, scanning signals that sequentially become at a high level (active) by each one horizontal scanning period is provided to the gate bus lines in the display unit 600.

In the present embodiment, the first gate clock signal CK1, the second gate clock signal CK2, and the first clock CKA function as circuit-control clock signals for controlling operations of bistable circuits in the shift register 410.

### 1.3 Configuration of Bistable Circuit

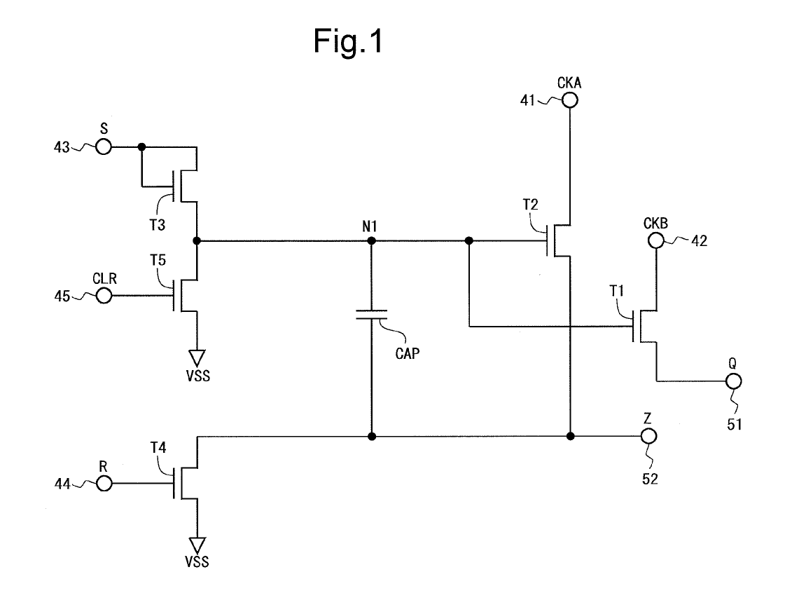

FIG. 1 is a circuit diagram showing a configuration (a configuration of one stage of the shift register 410) of the bistable circuit in the present embodiment. As shown in FIG. 1, this bistable circuit includes five thin-film transistors T1 to T5, and one capacitor CAP. The bistable circuit also has five input terminals 41 to 45 and two output terminals 51, 52, in addition to an input terminal for the direct-current power source potential VSS of a low level. Here, a reference numeral 41 is affixed to an input terminal that receives the first clock CKA, a reference numeral 42 is affixed to an input terminal that receives the second clock CKB, a reference numeral 43 is affixed to an input terminal that receives the set signal S, a reference numeral 44 is affixed to an input terminal that receives the reset signal R, and a reference numeral 45 is affixed to an input terminal that receives the clear signal CLR. Further, a reference numeral 51 is affixed to an output terminal that outputs the state signal Q, and a reference numeral 52 is affixed to an output terminal that outputs the other-stage control signal Z.

Next, a connection relationship between constituent elements in the bistable circuit is described. A gate terminal of the thin-film transistor T1, a gate terminal of the thin-film transistor T2, a source terminal of the thin-film transistor T3, a drain terminal of the thin-film transistor T5, and one end of the capacitor CAP are connected to each other. Note that a region (a wiring) in which these constituent elements are connected to each other is called a “first node” for convenience, and a reference symbol N1 is affixed to the first node.

For the thin-film transistor T1, a gate terminal is connected to the first node N1, a drain terminal is connected to the input terminal 42, and a source terminal is connected to the output terminal 51. For the thin-film transistor T2, a gate terminal is connected to the first node N1, a drain terminal is connected to the input terminal 41, and a source terminal is connected to the output terminal 52. For the thin-film transistor T3, a gate terminal and a drain terminal are connected to the input terminal 43 (that is, in a diode connection), and a source terminal is connected to the first node N1. For the thin-film transistor T4, a gate terminal is connected to the input terminal 44, a drain terminal is connected to the output terminal 52, and a source terminal is connected to an input terminal for the direct-current power source potential VSS. For the thin-film transistor T5, a gate terminal is connected to the input terminal 45, a drain terminal is connected to the first node N1, and a source terminal is connected to an input terminal for the direct-current power source potential VSS. For the capacitor CAP, one end is connected to the first node N1, and the other end is connected to the output terminal 52.

Functions of the constituent elements in the bistable circuit are described next. The thin-film transistor T1 provides a potential of the second clock CKB to the output terminal 51, when a potential of the first node N1 is at a high level. The thin-film transistor T2 provides a potential of the first clock CKA to the output terminal 52, when a potential of the first node N1 is at a high level. The thin-film transistor T3 changes the potential of the first node N1 to a high level, when the set signal S is at a high level. The thin-film transistor T4 changes the potential of the other-stage control signal Z (the potential of the output terminal 52) to a low level, when the reset signal R is at a high level. The thin-film transistor T5 changes the potential of the first node N1 to a low level, when the clear signal CLR is at a high level. The capacitor CAP functions as a compensation capacitance for maintaining the potential of the first node N1 at a high level during a period when a gate bus line that is connected to the bistable circuit is in a selected stated.

In the present embodiment, note that an output-control switching element is realized by the thin-film transistor T1, a first output node is realized by the output terminal 51 that outputs the state signal Q, and a second output node is realized by the output terminal 52 that outputs the other-stage control signal Z.

### 1.4 Operation of Bistable Circuit

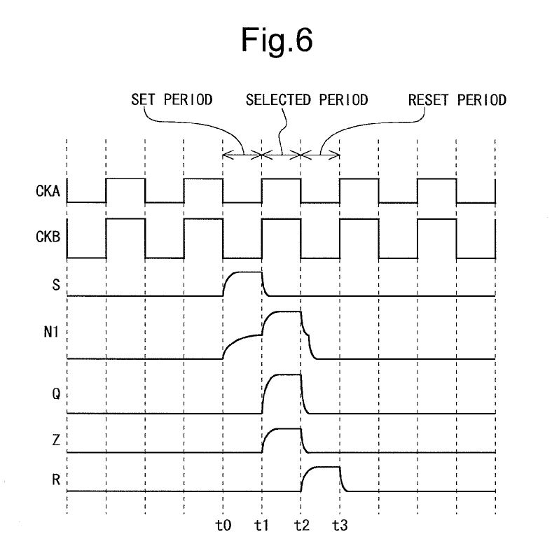

Next, an operation of the bistable circuit in the present embodiment is described with reference to FIGS. 1 and 6. In FIG. 6, a period from a time point t1 to a time point t2 corresponds to a selected period. Note that in the following, one horizontal scanning period immediately before the selected period is called a “set period”, and one horizontal scanning period immediately after the selected period is called a “reset period”. Further, a period other than the selected period, the set period, and the reset period is called a “normal operation period”.

During a period before the time point t0 (the normal operation period), a potential of the first node N1, a potential of the state signal Q (a potential of the output terminal 51), and a potential of the other-stage control signal Z (a potential of the output terminal 52) are at low levels. When reaching the time point to, a pulse of the set signal S is provided to the input terminal 43. Because the thin-film transistor T3 is in a diode connection as shown in FIG. 1, the thin-film transistor T3 becomes in an on state based on the pulse of the set signal S, and the capacitor CAP is charged. Accordingly, the potential of the first node N1 changes from the low level to the high level, and the thin-film transistors T1, T2 become in an on state. During the set period (during a period from the time point t0 to the time point t1), the first clock CKA and the second clock CKB are at low levels. Therefore, during the set period, the potential of the state signal Q and the potential of the other-stage control signal Z are maintained at low levels.

When reaching the time point t1, the first clock CKA and the second clock CKB change from the low levels to high levels. At this time, since the thin-film transistor T1 is in the on state, the potential of the state signal Q increases together with an increase of the potential of the input terminal 42. Further, since the thin-film transistor T2 is also in the on state, the potential of the other-stage control signal Z (the potential of the output terminal 52) increases together with an increase of the potential of the input terminal 41. Here, since the capacitor CAP is provided between the first node N1 and the output terminal 52 as shown in FIG. 1, the potential of the first node N1 also increases together with the increase of the potential of the output terminal 52 (the first node N1 is bootstrapped). As a result, a large voltage is applied to the thin-film transistor T1, and the potential of the state signal Q increases to the potential of the high level of the second clock CKB. Accordingly, a gate bus line that is connected to the output terminal 51 of the bistable circuit becomes in a selected state.

When reaching the time point t2, the second clock CKB changes from the high level to the low level. Accordingly, the potential of the state signal Q decreases together with a decrease of the potential of the input terminal 42. At the time point t2, the first clock CKA changes from the high level to the low level. Accordingly, the potential of the other-stage control signal Z decreases together with a decrease of the potential of the input terminal 41, and the potential of the first node N1 also decreases via the capacitor CAP. Further, at the time point t2, the reset signal R changes from the low level to a high level. Accordingly, the thin-film transistor T4 becomes in an on state, and the potential of the other-stage control signal Z quickly changes to a low level. During a period (a normal operation period) after ending the reset period, a potential of the first node N1, a potential of the state signal Q, and a potential of the other-stage control signal Z are at low levels.

### 1.5 Effect

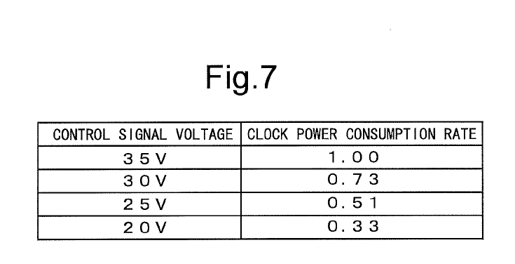

According to the present embodiment, from each bistable circuit in the shift register 410, the state signal Q that becomes a scanning signal for driving a gate bus line which is connected to the corresponding each bistable circuit, and the other-stage control signal Z for controlling a bistable circuit of a stage which is different from that of the corresponding each bistable circuit are outputted. Here, the second clock CKB as a clock signal having a relatively large amplitude (an amplitude similar to a conventional amplitude) is provided to a drain terminal of the thin-film transistor T1 that functions as an output control transistor. Therefore, a voltage that is applied to a gate bus line during a selected period does not become smaller than that in the past. On the other hand, the first clock CKA as a clock signal of a relatively small amplitude (an amplitude smaller than a conventional amplitude) is provided to a drain terminal of the thin-film transistor T2 which is a transistor for controlling an output of the other-stage control signal Z. In general, power consumption W due to a circuit parasitic capacitance is proportional to a product of a square of a voltage V (an amplitude), a capacitance value C of the parasitic capacitance, and a frequency f. Here, since the frequency f of the clock signal is relatively large, and since the power consumption W is proportional to the square of the voltage V, the power consumption W is greatly reduced by decreasing a potential at a high-level side of the clock signal (here, the first clock CKA as a circuit-control clock signal). For example, when power consumption is 1 when a voltage (hereinafter, referred to as a “control signal voltage”) at the high-level side of the circuit-control clock signal is 35 V, a relationship between the control signal voltage and the power consumption (due to a circuit parasitic capacitance) becomes as shown in FIG. 7. It can be understood from FIG. 7, for example, that “when the control signal voltage is lowered from 35 V to 20 V, the power consumption becomes about one third”.

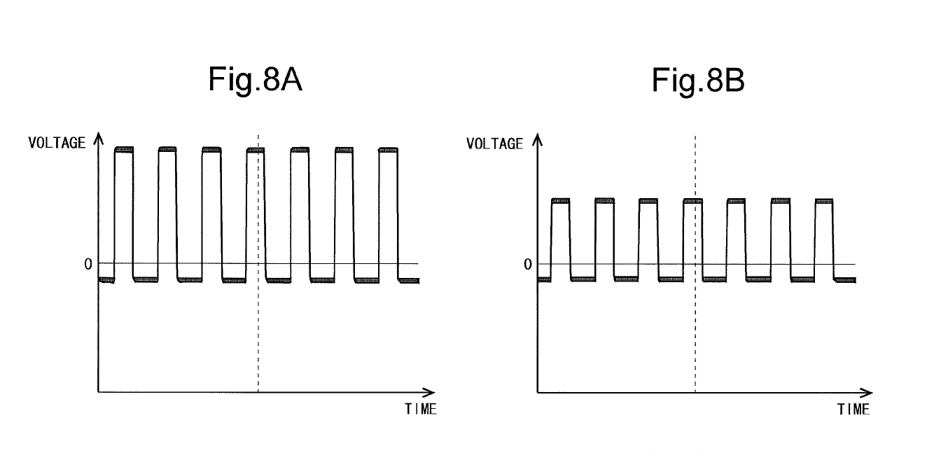

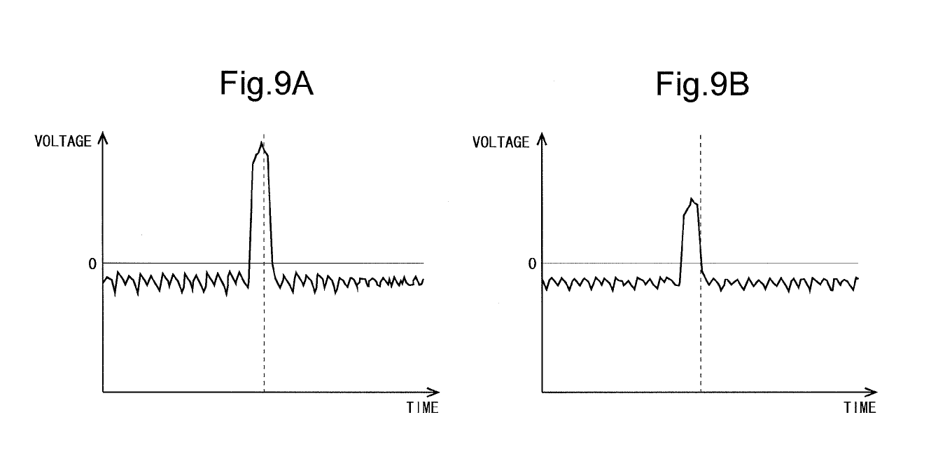

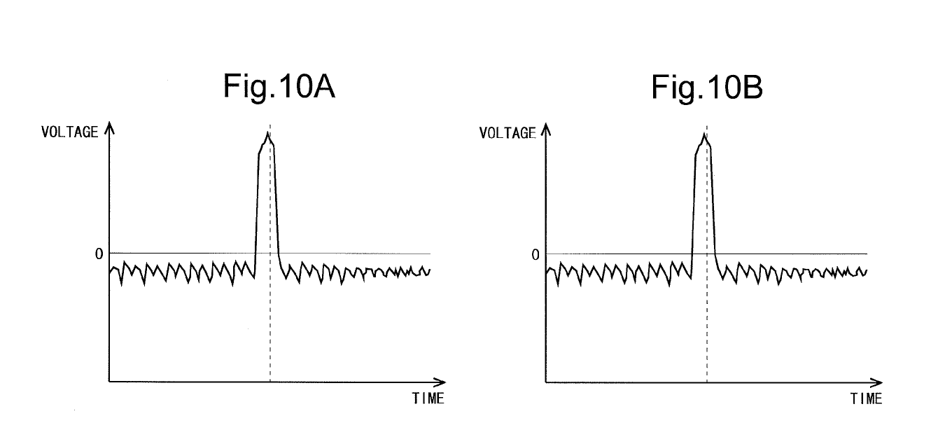

Next, a fact that a potential of the state signal Q becomes sufficiently high during the selected period in the present embodiment is described by showing a measurement result of the output. FIG. 8A is a waveform diagram of a circuit-control clock signal in a conventional example. FIG. 8B is a waveform diagram of the circuit-control clock signal (the first clock CKA) in the present embodiment. As can be understood from FIGS. 8A and 8B, in the present embodiment, a potential at a high-level side of the circuit-control clock signal is set smaller than that in the past. FIG. 9A is a waveform diagram of the state signal Q when a circuit-control clock signal of a waveform shown in FIG. 8A is provided to each stage of a shift register in a configuration of the conventional example. FIG. 9B is a waveform diagram of the state signal Q when a circuit-control clock signal of a waveform shown in FIG. 8B is provided to each stage of a shift register in the configuration of the conventional example. As can be understood from FIGS. 9A and 9B, in the configuration of the conventional example, when a potential at a high-level side of the circuit-control clock signal is set lower, a potential of the state signal Q during a selected period cannot be sufficiently increased. FIG. 10A is a waveform diagram of the state signal Q when a circuit-control clock signal of the waveform shown in FIG. 8A is provided to each stage of a shift register in the configuration of the present embodiment (see FIG. 1). FIG. 10B is a waveform diagram of the state signal Q when the circuit-control clock signal of the waveform shown in FIG. 8B is provided to each stage of the shift register in the configuration of the present embodiment. As can be understood from FIGS. 10A and 10B, in the configuration of the present embodiment, even when the potential at a high-level side of the circuit-control clock signal is set lower than that in the past, a potential of the state signal Q during the selected period can be increased to a sufficiently high potential.

As described above, according to the present embodiment, the power consumption in the shift register 410 can be reduced as compared with that in the past, without lowering the voltage applied to the gate bus line during the selected period as compared with that in the past.

### 1.6 Modification

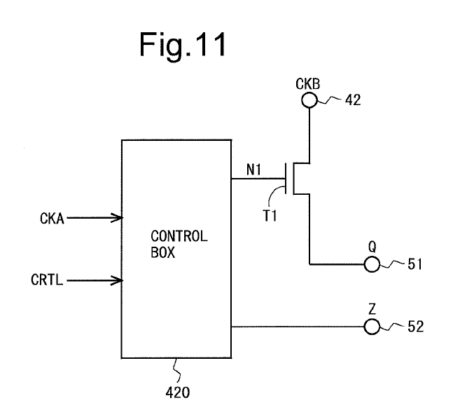

In the above first embodiment, while the bistable circuit in the shift register 410 is configured as shown in FIG. 1, the present invention is not limited thereto. As shown in FIG. 11, the bistable circuit can also have a configuration other than the configuration shown in FIG. 1, so far as the bistable circuit includes the output terminal 51 for outputting the state signal Q, the output terminal 52 for outputting the other-stage control signal Z, the output control switching element (the thin-film transistor, for example) T1 having the first conductive terminal connected to the input terminal 42 for a clock signal having a relatively large amplitude and having the second conductive terminal connected to the output terminal 51, and a control box 420 as a control unit that controls an on/off state of the output-control switching element and the potential of the output terminal 52 based on the circuit-control clock signal CKA and the control signals (such as the set signal S, the reset signal R, and the clear signal CLR, in the first embodiment) CRTL.

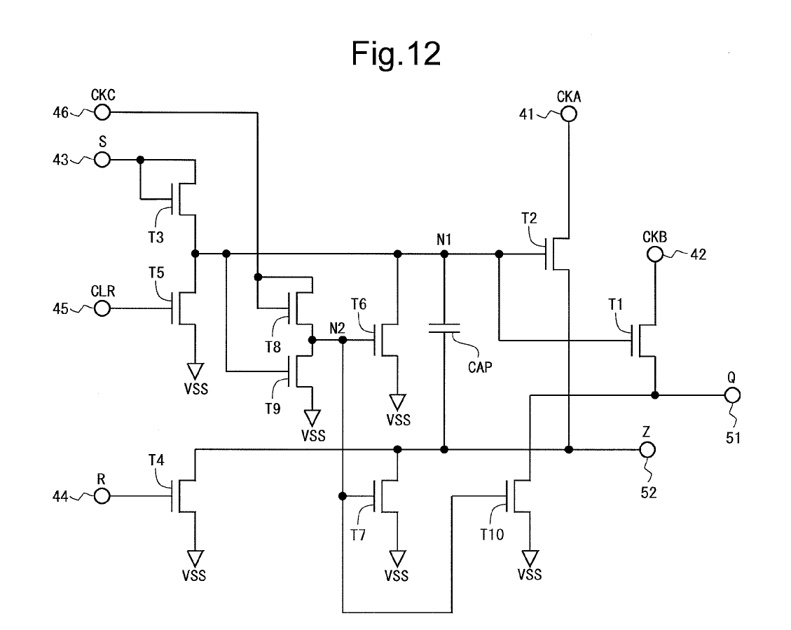

FIG. 12 is a circuit diagram showing a configuration example of a bistable circuit according to a modification of the first embodiment. In the present modification, in addition to the constituent elements in the first embodiment shown in FIG. 1, there are provided five thin-film transistors T6 to T10, and an input terminal 46 for receiving a third clock CKC of which an amplitude is equal to that of the first clock CKA and of which a phase is shifted by one horizontal scanning period from that of the first clock CKA. A gate terminal of the thin-film transistor T6, a gate terminal of the thin-film transistor T7, a source terminal of the thin-film transistor T8, a drain terminal of the thin-film transistor T9, and a gate terminal of the thin-film transistor T10 are connected to each other. Note that, a region (a wiring) in which these constituent elements are connected to each other is called a “second node” for convenience, and a reference symbol N2 is affixed to the second node.

For the thin-film transistor T6, the gate terminal is connected to the second node N2, the drain terminal is connected to the first node N1, and a source terminal is connected to an input terminal of the direct-current power source potential VSS. For the thin-film transistor T7, the gate terminal is connected to the second node N2, a drain terminal is connected to the output terminal 52, and a source terminal is connected to the input terminal of the direct-current power source potential VSS. For the thin-film transistor T8, a gate terminal and a drain terminal are connected to the input terminal 46 (that is, in a diode connection), and the source terminal is connected to the second node N2. For the thin-film transistor T9, a gate terminal is connected to the first node N1, the drain terminal is connected to the second node N2, and a source terminal is connected to the input terminal for the direct-current power source potential VSS. For the thin-film transistor T10, the gate terminal is connected to the second node N2, a drain terminal is connected to the output terminal 51, and a source terminal is connected to the input terminal for the direct-current power source potential VSS.

The thin-film transistor T6 changes the potential of the first node N1 to the low level, when the potential of the second node N2 is at the high level. The thin-film transistor T7 changes the potential of the other-stage control signal Z (the potential of the output terminal 52) to a low level, when the potential of the second node N2 is at the high level. The thin-film transistor T8 changes the potential of the second node N2 to the high level, when the third clock CKC is at the high level. The thin-film transistor T9 changes the potential of the second node N2 to the low level, when the potential of the first node N1 is at the high level. The thin-film transistor T10 changes the potential of the state signal Q (the potential of the output terminal 51) to the low level, when the potential of the second node N2 is at the high level.

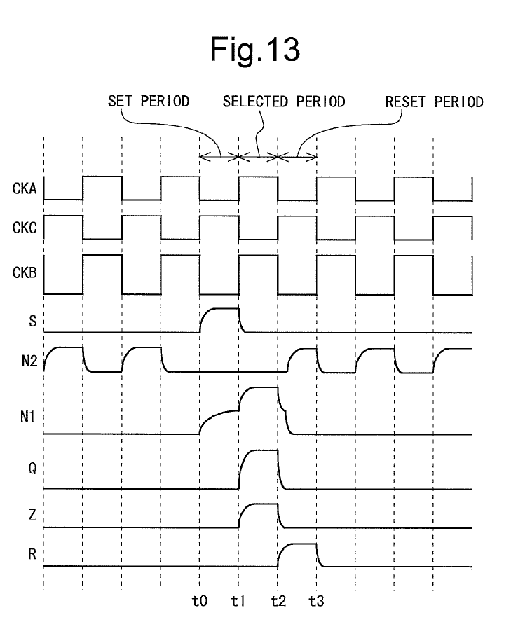

An operation of the bistable circuit in the present modification is described next with reference to FIGS. 12 and 13. During a period before the time point t0 (the normal operation period), a potential of the first node N1, a potential of the state signal Q (a potential of the output terminal 51), and a potential of the other-stage control signal Z (a potential of the output terminal 52) are at the low levels. During the period before the time point t0, a potential of the second node N2 becomes at the high level every other horizontal scanning period, according to a change of a potential of the third clock CKC. Consequently, the potential of the second node N2 becomes at the high level by the thin-film transistor T8 becoming in an on state every other horizontal scanning period. When the potential of the second node N2 becomes at the high level, the thin-film transistors T6, T7, and T10 become in on states. Thus, the potential of the first node N1, the potential of the other-stage control signal Z, and the potential of the state signal Q are drawn to the direct-current power source potential VSS of a low level. Therefore, even when a leakage of current occurs in the thin-film transistors T1, T2 during the normal operation period, an increase of the potential of the first node N1, the potential of the other-stage control signal Z, and the potential of the state signal Q attributable to the leakage of the current is suppressed.

During the set period (during a period from the time point t0 to the time point t1) and during the selected period (during a period from the time point t1 to the time point t2), operations similar to those in the first embodiment are performed. Note that in these periods, since the potential of the first node N1 is at the high level, the thin-film transistor T9 becomes in an on state. Therefore, even when the third clock CKC becomes at the high level, the potential of the second node N2 is maintained at the low level, and the potential of the first node N1, the potential of the other-stage control signal Z, and the potential of the state signal Q do not decrease.

When reaching the time point t2, the second clock CKB changes from the high level to the low level. Accordingly, the potential of the state signal Q decreases together with a decrease of the potential of the input terminal 42. At the time point t2, the first clock CKA changes from the high level to the low level. Accordingly, the potential of the other-stage control signal Z decreases together with a decrease of the potential of the input terminal 41, and the potential of the first node N1 also decreases via the capacitor CAP. Further, at the time point t2, the reset signal R changes from the low level to the high level. Accordingly, the thin-film transistor T4 becomes in an on state, and the potential of the other-stage control signal Z quickly changes to the low level. During the reset period, the potential of the second node N2 changes from the low level to the high level. Accordingly, the thin-film transistors T6, T7, and T10 become in on states, and the potential of the first node N1, the potential of the other-stage control signal Z, and the potential of the state signal Q securely decrease to the low levels. During a period (the normal operation period) after ending the reset period, an operation similar to that during the period before the time point t0 is performed.

In the present modification, focusing attention on a vicinity of the output portion of the bistable circuit, in a similar manner to that in the first embodiment, the second clock CKB as a clock signal having a relatively large amplitude (an amplitude similar to the conventional amplitude) is provided to a drain terminal of the thin-film transistor T1 that functions as an output-control transistor, and the first clock CKA as a clock signal having a relatively small amplitude (an amplitude smaller than the conventional amplitude) is provided to a drain terminal of the thin-film transistor T2 which is a transistor for controlling the output of the other-stage control signal Z. Therefore, power consumption in the shift register 410 can be reduced as compared with that in the past, without lowering a voltage applied to a gate bus line during the selected period as compared with that in the past.

### 2. Second Embodiment

### 2.1 Configuration of Gate Driver

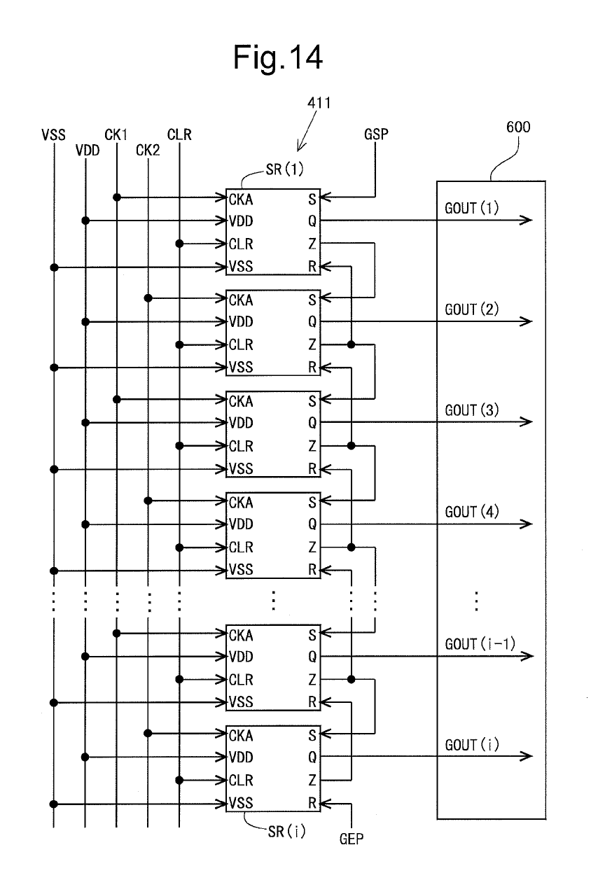

FIG. 14 is a block diagram showing a configuration of a shift register 411 in a gate driver 400 according to a second embodiment of the present invention. Since an overall configuration and an operation of a liquid crystal display device are similar to those in the first embodiment, the description thereof is omitted.

In the present embodiment, an input terminal for receiving a direct-current power source potential VDD of a high level is provided, in place of the input terminal for the second clock CKB in the first embodiment (see FIG. 4). In the shift register 411, a first gate clock signal CK1 and a second gate clock signal CK2 as two-phase clock signals are provided as a gate clock signal GCK. For the first gate clock signal CK1 and the second gate clock signal CK2, phases are shifted by one horizontal scanning period from each other, and each of them becomes in a state of a high level (an H level) during one horizontal scanning period out of two horizontal scanning periods. Potentials at high-level sides of the first gate clock signal CK1 and the second gate clock signal CK2 are set smaller than the direct-current power source potential VDD. For example, the direct-current power source potential VDD is set to 35 V, and the potentials at the high-level sides of the first gate clock signal CK1 and the second gate clock signal CK2 are set to 20 V.

Signals that are provided to input terminals of each stage (each bistable circuit) of the shift register 411 are as follows (see FIG. 14). In odd stages, the first gate clock signal CK1 is provided as a first clock CKA. In even stages, the second gate clock signal CK2 is provided as the first clock CKA. The direct-current power source potential VDD of a high level is commonly provided to all the bistable circuits. A clear signal CLR, a direct-current power source potential VSS of a low level, a set signal S, and a rest signal R are similar to those in the first embodiment. A state signal Q and an other-stage control signal Z that are outputted from each stage (each bistable circuit) of the shift register 411 are also similar to those in the first embodiment.

Note that in the present embodiment, the first gate clock signal CK1 and the first clock CKA function as circuit-control clock signals for controlling an operation of the bistable circuit in the shift register 411.

### 2.2 Configuration of Bistable Circuit

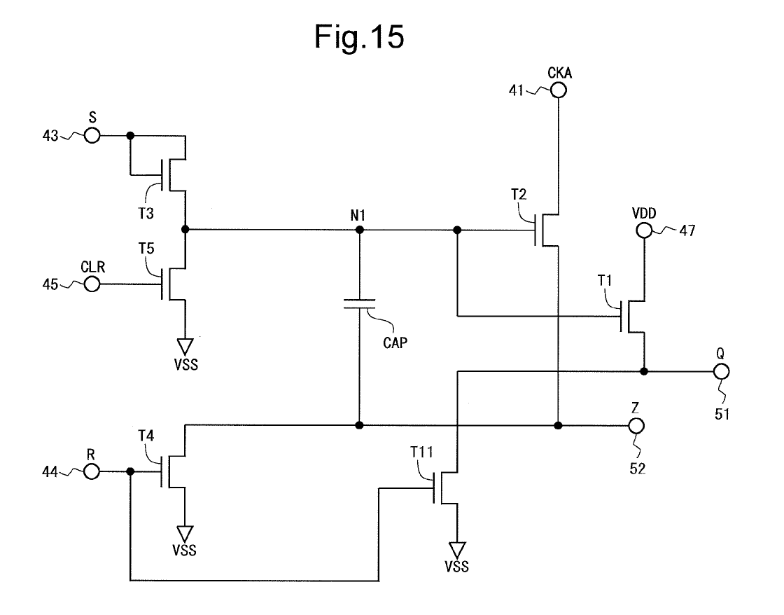

FIG. 15 is a circuit diagram showing a configuration of the bistable circuit in the present embodiment. In the present embodiment, in the bistable circuit, an input terminal 47 for receiving the direct-current power source potential VDD of a high level is provided, in place of the input terminal 42 for the second clock CKB in the first embodiment. The direct-current power source potential VDD of the high level is provided to a drain terminal of a thin-film transistor T1 that functions as an output control transistor. A thin-film transistor T11 is provided, in addition to the constituent elements of the first embodiment. For the thin-film transistor T11, a gate terminal is connected to an input terminal 44, a drain terminal is connected to an output terminal 51, and a source terminal is connected to an input terminal for the direct-current power source potential VSS.

### 2.3 Operation of Bistable Circuit

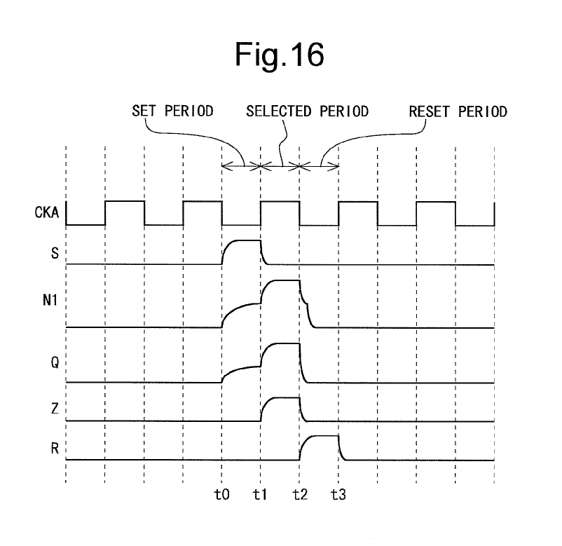

Next, an operation of the bistable circuit in the present embodiment is described with reference to FIGS. 15 and 16. During a period before a time point t0 (a normal operation period), a potential of the first node N1, a potential of the state signal Q (a potential of the output terminal 51), and a potential of the other-stage control signal Z (a potential of an output terminal 52) are at the low levels. When reaching the time point to, a pulse of the set signal S is provided to an input terminal 43. Since a thin-film transistor T3 is in a diode connection as shown in FIG. 15, the thin-film transistor T3 becomes in an on state based on a pulse of the set signal S, and a capacitor CAP is charged. Accordingly, the potential of the first node N1 changes from the low level to the high level, and the thin-film transistors T1, T2 become in on states. In the present embodiment, the direct-current power source potential VDD of the high level is being provided to a drain terminal of the thin-film transistor T1. Therefore, by the thin-film transistor T1 becoming in an on state, the potential of the state signal Q increases during a set period (during a period from the time point t0 to a time point t1) as shown in FIG. 16. Further, during the set period, the first clock CKA is at a low level. Therefore, during the set period, the potential of the other-stage control signal Z is maintained at a low level.

When reaching the time point t1, the first clock CKA changes from the low level to the high level. At this time, since the thin-film transistor T2 is in the on state, the potential of the other-stage control signal Z (the potential of the output terminal 52) increases together with an increase of the potential of the input terminal 41. Here, since the capacitor CAP is provided between the first node N1 and the output terminal 52 as shown in FIG. 15, the potential of the first node N1 increases together with the increase of the potential of the output terminal 52 (the first node N1 is bootstrapped). As a result, a large voltage is applied to the thin-film transistor T1, and the potential of the state signal Q increases to the potential of the direct-current power source potential VDD of the high level. Accordingly, a gate bus line connected to the output terminal 51 of this bistable circuit is in a selected state.

When reaching a time point t2, the first clock CKA changes from the high level to the low level. Accordingly, the potential of the other-stage control signal Z decreases together with a decrease of the potential of the input terminal 41, and the potential of the first node N1 also decreases via the capacitor CAP. At the time point t2, the reset signal R changes from the low level to the high level. Accordingly, the thin-film transistors T4, T11 become in on states. By the thin-film transistor T4 becoming in the on state, the potential of the other-stage control signal Z quickly changes to the low level, and by the thin-film transistor T11 becoming in the on state, the potential of the state signal Q quickly changes to the low level. During a period (the normal operation period) after ending the reset period, the potential of the first node N1, the potential of the state signal Q, and the potential of the other-stage control signal Z are at the low levels.

### 2.4 Effect

According to the present embodiment, since the potential at a high-level side of the first clock CKA as a circuit-control clock signal is set lower than that in the past, power consumption in the shift register 411 is reduced as compared with that in the past, in a similar manner to that in the first embodiment. Further, according to the present embodiment, unlike the first embodiment, the direct-current power source potential VDD is provided to the drain terminal of the thin-film transistor T1. Therefore, during an operation of the shift register 411, power consumption attributable to a parasitic capacitance of the thin-film transistor T1 is not generated. Accordingly, power consumption in the shift register 411 can be significantly reduced as compared with that in the past, without lowering a voltage applied to the gate bus line during the selected period as compared with that in the past.

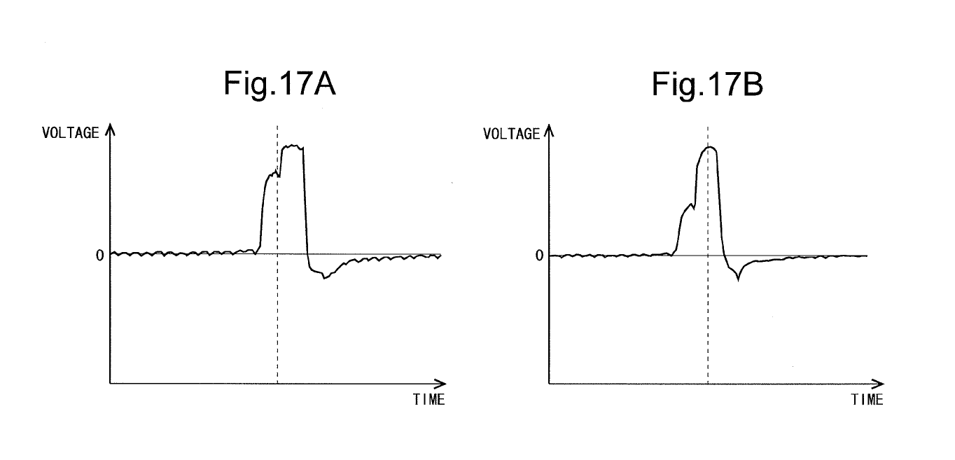

Next, a fact that a potential of the state signal Q becomes sufficiently high during the selected period in the present embodiment is described by showing a measurement result of an output. FIG. 8A is a waveform diagram of a circuit-control clock signal in a conventional example. FIG. 8B is a waveform diagram of a circuit-control clock signal (the first clock CKA) according to the present embodiment. As can be understood from FIGS. 8A and 8B, in the present embodiment, a potential at a high-level side of the circuit-control clock signal is set smaller than that in the past. FIG. 9A is a waveform diagram of the state signal Q when a circuit-control clock signal of a waveform shown in FIG. 8A is provided to each stage of a shift register in a configuration of the conventional example. FIG. 9B is a waveform diagram of the state signal Q when a circuit-control clock signal of a waveform shown in FIG. 8B is provided to each stage of a shift register in the configuration of the conventional example. As can be understood from FIGS. 9A and 9B, in the configuration of the conventional example, when a potential at a high-level side of the circuit-control clock signal is set lower, a potential of the state signal Q during a selected period cannot be sufficiently increased. FIG. 17A is a waveform diagram of the state signal Q when a circuit-control clock signal of the waveform shown in FIG. 8A is provided to each stage of a shift register in the configuration of the present embodiment (see FIG. 15). FIG. 17B is a waveform diagram of the state signal Q when a circuit-control clock signal of the waveform shown in FIG. 8B is provided to each stage of a shift register in the configuration of the present embodiment. As can be understood from FIGS. 17A and 17B, in the configuration of the present embodiment, even when a potential at a high-level side of the circuit-control clock signal is set lower than that in the past, a potential of the state signal Q during a selected period can be increased to a sufficiently high potential.

As described above, according to the present embodiment, power consumption in the shift register 411 can be reduced as compared with that in the past, without lowering a voltage applied to the gate bus line during the selected period as compared with that in the past.

### 2.5 Modification

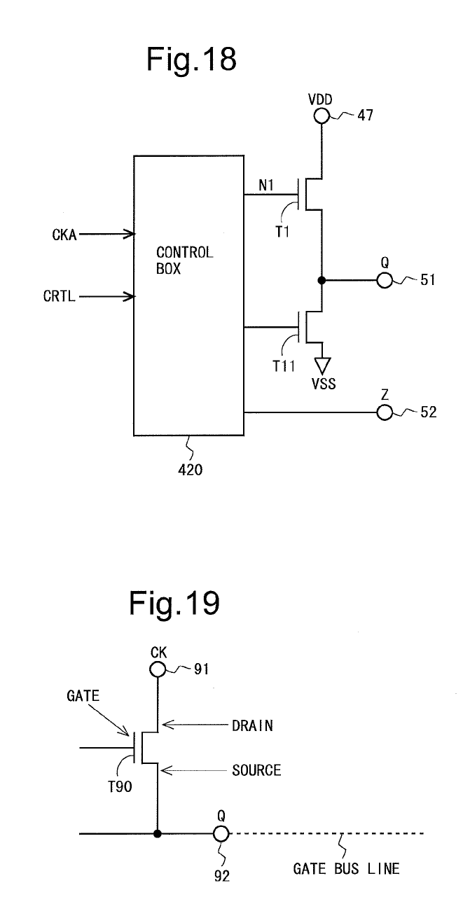

In the second embodiment, while a bistable circuit in the shift register 411 is configured as shown in FIG. 15, the present invention is not limited thereto. As shown in FIG. 18, the bistable circuit can also have a configuration other than the configuration shown in FIG. 15, so far as the bistable circuit includes the output terminal 51 for outputting the state signal Q, the output terminal 52 for outputting the other-stage control signal Z, the output control switching element T1 having a first conductive terminal connected to the input terminal 47 of the direct-current power source potential VDD of a high level and having a second conductive terminal connected to the output terminal 51, the switching element T11 having a first conductive terminal connected to the output terminal 51 and having a second conductive terminal connected to an input terminal for the direct-current power source potential VSS (or a clock signal) of the low level, and a control box 420 as a control unit that controls an on/off state of the output-control switching element T1, an on/off state of the switching element T11, and a potential of the output terminal 52 based on the circuit-control clock signal CKA and a control signal (such as the set signal S, the reset signal R, and a clear signal CLR, in the second embodiment) CRTL.

### DESCRIPTION OF REFERENCE CHARACTERS

41 to 47: INPUT TERMINALS (OF BISTABLE CIRCUIT)
51, 52: OUTPUT TERMINALS (OF BISTABLE CIRCUIT)
300: SOURCE DRIVER (VIDEO SIGNAL LINE DRIVE CIRCUIT)
400: GATE DRIVER (SCANNING SIGNAL LINE DRIVE CIRCUIT)
410, 411: SHIFT REGISTERS
600: DISPLAY UNIT
SR(1) to SR(i): BISTABLE CIRCUITS
CAP: CAPACITOR (CAPACITATIVE ELEMENT)
T1 to T10: THIN-FILM TRANSISTORS
N1, N2: FIRST NODE, SECOND NODE
GL1 to GLi: GATE BUS LINES
SL1 to SLj: SOURCE BUS LINES
CK1, CK2, CK1H, CK2H: FIRST GATE CLOCK SIGNAL, SECOND GATE CLOCK SIGNAL, THIRD GATE CLOCK SIGNAL, FOURTH GATE CLOCK SIGNAL
CKA, CKB, CKC: FIRST CLOCK, SECOND CLOCK, THIRD CLOCK
S: SET SIGNAL
R: RESET SIGNAL
Q: STATE SIGNAL
Z: OTHER-STAGE CONTROL SIGNAL
CLR: CLEAR SIGNAL
GOUT: SCANNING SIGNAL
VDD: DIRECT-CURRENT POWER SOURCE POTENTIAL OF HIGH LEVEL
VSS: DIRECT-CURRENT POWER SOURCE POTENTIAL OF LOW LEVEL

1. A shift register, being provided on a substrate on which a pixel circuit for displaying an image is formed, and comprising a plurality of bistable circuits each having a first state and a second state and being connected in series to each other, the plurality of bistable circuits sequentially becoming in a first state based on a circuit-control clock signal provided from an outside of each bistable circuit, wherein
each bistable circuit includes:
a first output node outputting a state signal indicating one of the first state and the second state to an outside;
an output-control switching element having a control terminal, a first conductive terminal, and a second conductive terminal, the second conductive element being connected to the first output node;
a second output node outputting an other-stage control signal for controlling an operation of a bistable circuit other than said each bistable circuit; and
a control unit controlling a potential of a first node connected to the control terminal of the output-control switching element and a potential of the second output node, based on the circuit-control clock signal and the other-stage control signal outputted from a bistable circuit other than said each bistable circuit, and wherein
a potential supplied by a power source of a system separate from a system of a power source generating the circuit-control clock signal is provided to the first conductive terminal of the output-control switching element, and
a first potential as a potential at a high-level side of the circuit-control clock signal is lower than a second potential as a potential to be provided to the first conductive terminal of the output-control switching element during a period in which the state signal is to be set to the first state.

2. The shift register according to claim 1, wherein
a clock signal whose potential at a high-level side is set to the second potential is provided to the first conductive terminal of the output-control switching element.

3. The shift register according to claim 1, wherein
each bistable circuit further includes a switching element for lowering a potential of the first output node based on the circuit-control clock signal or an other-stage control signal outputted from a bistable circuit other than said each bistable circuit, and
a potential that is being provided to the first conductive terminal of the output-control switching element is supplied by a direct-current power source.

4. The shift register according to claim 1, wherein
a potential based on a pixel rated voltage which is a voltage defined to drive the pixel circuit is provided to the first conductive terminal of the output-control switching element.

5. The shift register according to claim 4, wherein
a size of the first potential is equal to or larger than a half of a size of a potential based on the pixel rated voltage.

6. A scanning signal line drive circuit of a display device, for driving a plurality of scanning signal lines arrayed in a display unit including the pixel circuit, the scanning signal line drive circuit comprising:
the shift register according to claim 1, wherein
the plurality of bistable circuits are provided to correspond to the plurality of scanning signal lines at one to one, and
each bistable circuit provides a state signal outputted from the first output node, to a scanning signal line corresponding to said each bistable circuit, as a scanning signal.

7. A display device including the display unit, comprising:
a scanning signal line drive circuit according to claim 6.
